(19) United States
(12) Patent Application Publication
(10) Pub. No.: US 2015/0286691 A1
(43) Pub. Date: Oct. 8, 2015

(54) DATA VIEW EXPOSURE MECHANISMS

(71) Applicant: Microsoft Corporation, Redmond, WA (US)

(72) Inventors: Brad Olenick, Redmond, WA (US); Justin Beckwith, Bellevue, WA (US); Marcin Kanclerz, Redmond, WA (US); Steven Sanderson, Bristol (GB)

(73) Assignee: Microsoft Corporation, Redmond, WA (US)

(21) Appl. No.: 14/269,888

(22) Filed: May 5, 2014

Related U.S. Application Data
(60) Provisional application No. 61/974,126, filed on Apr. 2, 2014.

(51) Int. Cl. G06F 17/30; G06F 3/0482

(52) U.S. Cl. CPC G06F 17/30554; G06F 3/0482

(57) ABSTRACT

The use of a data view component to expose data to a user interface element display logic component. The data exposed by the data view component is from a data set within the data cache. The data view component is able to expose that data due to a binding with the data set. The data view component may improve the user experience by exposing a default data set (such as a null data set) until the requested data set is available, expose only the latest requested data set when there are multiple requests, quickly switch bindings from one data set to another, and/or safely release the binding once the user interface element display logic component ceases to exist.

### CROSS REFERENCE TO RELATED APPLICATIONS

This application claims the benefit of U.S. Provisional Application Ser. No. 61/974,126, filed Apr. 2, 2014, which provisional patent application is incorporated herein by reference in its entirety.

### BACKGROUND

A computing system often displays multiple user interface elements in order to provide the user with a rich user experience. In one common presentation paradigm, each user interface element is populated by a view model. A view model is a display logic component that transforms input data into an appropriate form for consumption by a user interface control that the displays the user interface element. In this paradigm, the input data comes from a data view component that provides a view on an underlying data set. In order to provide that view, the data view component uses a reference to bind to the underlying data set.

The underlying data set may be a data set within a local data cache. The local data cache keeps track of a reference count. When the data set is first referenced, the data cache begins the reference count with unity. Whenever a new reference is made to the data set, the reference count increments for that data set. Whenever an old reference to the data set is removed, the reference count for that data set decrements. If the reference count decrements to zero, then the data cache has the option of evicting or removing the data set from the data cache.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the use of a data view component to expose data to a user interface element display logic component. The data exposed by the data view component is from a data set within the data cache. The data view component is able to expose that data due to a binding with the data set.

In accordance with a first aspect described herein, the data view component receives a request from the user interface display logic component to access at least a portion of the data set. In response, the data view component requests the data set from the data cache. While waiting for the requested data set from the data cache, the data view component exposes at least a portion of a default data set (which could include a null data set) to the user interface element display logic. The default data set will not likely contain the data of interest to the user interface display logic component, but it will allow the user interface display logic component to cause default data to be displayed while awaiting population of the requested data. Once the data view component does bind to the requested data set, the requested data is then exposed to the user interface display logic component.

In accordance with a second aspect described herein, the data view component receives multiple requests to access different data sets from the user interface display logic component. In response to the first request, the data view component requests the first data set from the data cache. Also, in response to the second request, the data view component requests the second data set from the data cache. In response to the second request, the data view component ignores any results from the first request, and instead binds to the second data set when the second data set becomes available in the data cache for binding.

In accordance with a third aspect described herein, the data view component may change bindings to data sets in response to requests from the user interface element display logic component. When a first request is received from the user interface element display logic component, the data view is bound to the first data set. However, when a second request is received from the user interface element display logic component, the data view changes bindings to the second data set.

In accordance with a fourth aspect described herein, the data view component keeps track of the lifetime of the user interface element display logic component. In particular, when the data view component receives the request from the user interface element display logic component, the data view component also receives a lifetime reference object from the user interface element display logic component. The data view component binds to the data set in response to the request. However, when the user interface element display logic component no longer exists, the data view component receives notice of this by virtue of the data view component possessing the lifetime reference object. Accordingly, the data view component may appropriately release the binding to the data set.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates an environment that includes a data channel that populates a user interface element using a data cache in accordance with the principles described herein;

FIG. 3 illustrates a flowchart of a method for a data view component to expose default data to a user interface element display logic component while waiting for requested data;

FIG. 4 illustrates a flowchart of a method of the data view component exposing only the latest requested data set when there are multiple requests;

FIG. 5 illustrates a flowchart of a method of the data view component switching bindings from one data set to another;

FIG. 6 illustrates a flowchart of a method of the data view component safely releasing the binding once the user interface element display logic component ceases to exist; and

FIG. 7 illustrates an environment that is a specific example of the environment of FIG. 2, but now showing three data channels served by a data cache, and showing multiple available data caches.

### DETAILED DESCRIPTION

At least some embodiments described herein relate to the use of a data view component to expose data to a user interface element display logic component. The data exposed by the data view component is from a data set within the data cache. The data view component is able to expose that data due to a binding with the data set.

In accordance with a first aspect described herein, the data view component receives a request from the user interface display logic component to access at least a portion of the data set. In response, the data view component requests the data set from the data cache. While waiting for the requested data set from the data cache, the data view component exposes at least a portion of a default data set (which could be a null data set) to the user interface element display logic. The default data set will not likely contain the data of interest to the user interface display logic component, but it will allow the user interface display logic component to cause default data to be displayed while awaiting population of the requested data. Once the data view component does bind to the requested data set, the requested data is then exposed to the user interface display logic component.

In accordance with a second aspect described herein, the data view component receives multiple requests to access different data sets from the user interface display logic component. In response to the first request, the data view component requests the first data set from the data cache. Also, in response to the second request, the data view component requests the second data set from the data cache. In response to the second request, the data view component ignores any results from the first request, and instead binds to the second data set when the data set becomes available in the data cache for binding.

In accordance with a third aspect described herein, the data view component may change bindings to data sets in response to requests from the user interface element display logic component. When a first request is received from the user interface element display logic component, the data view is bound to the first data set. However, when a second request is received from the user interface element display logic component, the data view changes bindings to the second data set.

In accordance with a fourth aspect described herein, the data view component keeps track of the lifetime of the user interface element display logic component. In particular, when the data view component receives the request from the user interface element display logic component, the data view component also receives a lifetime reference object from the user interface element display logic component. The data view component binds to the data set in response to the request. However, when the user interface element display logic component no longer exists, the data view component receives notice of this by virtue of the data view component possessing the lifetime reference object. Accordingly, the data view component may appropriately release the binding to the data set.

Thus, the data view component may improve the user experience by exposing a default data set until the requested data set is available, by exposing only the latest requested data set when there are multiple requests, by quickly switching bindings from one data set to another, and/or by safely releasing the binding once the user interface element display logic component ceases to exist.

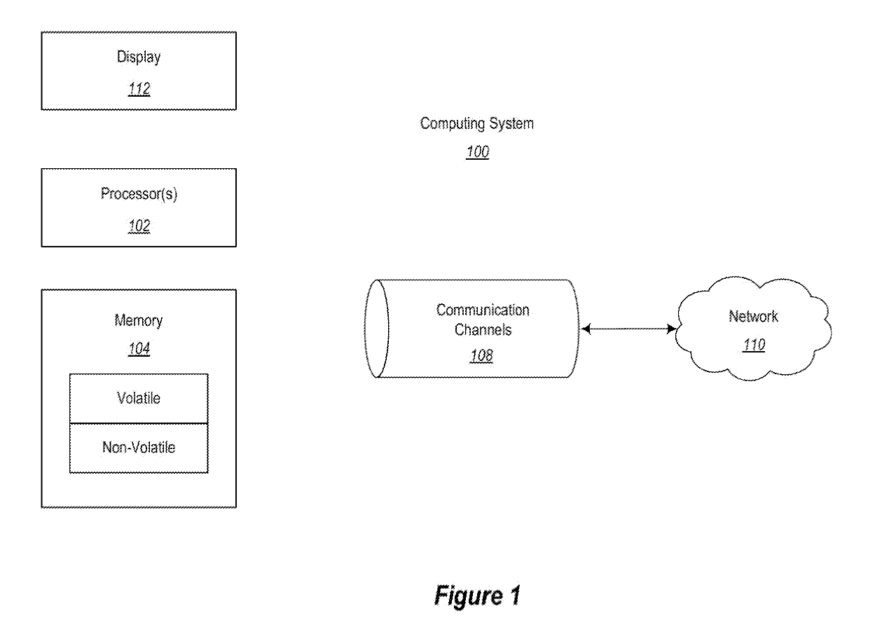

Some introductory discussion of a computing system will be described with respect to FIG. 1. Then, further embodiments will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 also includes a display 112 for displaying user interfaces such as those described herein.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

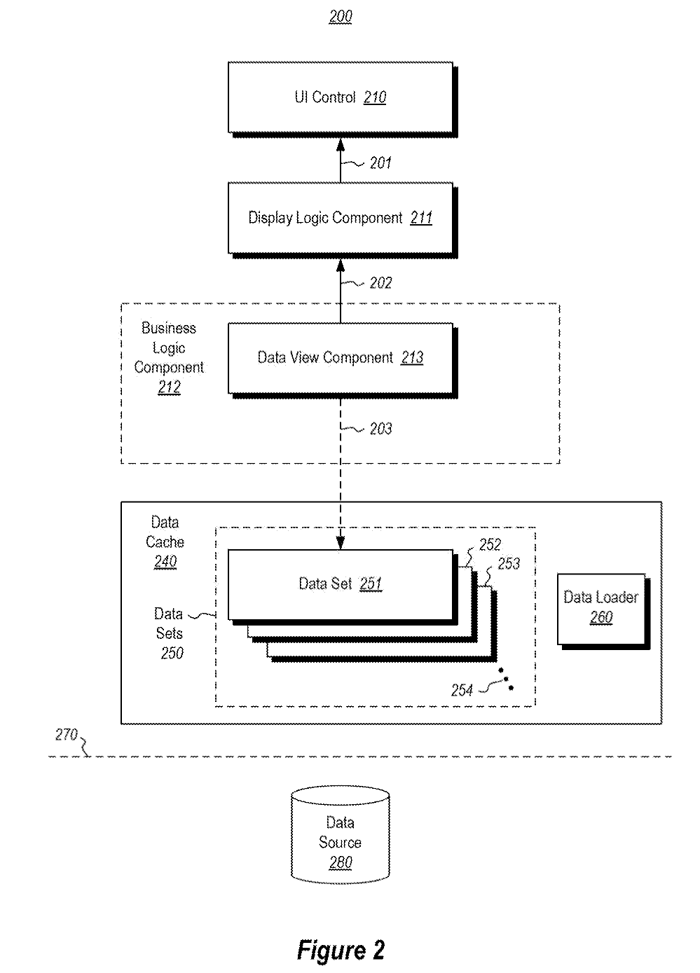

FIG. 2 illustrates an environment 200 that includes a data-driven user interface control 210. The user interface control 210 presents a user interface element in a data-driven manner using control input data 201. For instance, the environment 200 may be within the computing system 100 of FIG. 1, in which case, the user interface element is caused to be displayed on, for example, the display 112. For instance, the user interface control 210 may be a “view” as the term is used in the Model View ViewModel (MVVM) presentation paradigm or as a “controller” as the term is used in the Model-View-Controller (MVC) pattern.

The user interface control 210 receives the control input data 201 from a user interface element display logic component 211 (also called hereinafter a “display logic component”). The display logic component 211 receives input data 202 and processes the input data 202 to thereby generate the control input data 201. Thus, the display logic component 212 uses the input data 202 to generate control input data 201 that is in a proper form for consumption by the user interface control 210. The processing performed by the business logic component 212 may be as simple as passing all or portions of the input data to its output unchanged, or may be quite complicated, or may be somewhere in between. The display logic component 211 may be a “viewmodel” or “view model” as the term is used in the MVVM presentation paradigm, or may be a “view” as the term is used in the MVC pattern.

A business logic component 212 performs business logic and feeds resulting business logic output data (including input data 202) to the display logic component 211. For purposes of this description, it is the input data 202 provided by the data view component 213 that is of most relevance to the principles described herein. The business logic component 212 may be a “model” as the term is used in the MVVM presentation paradigm or as the term is used in the MVC pattern.

A data view component 213 operates within the business logic component 212 and serves to provide a view of a corresponding data set by exposing that view upward (e.g., in the form of input data 202) to a corresponding display logic processing component 211. The data view component 213 has a reference 203 to the corresponding data set 251 in the data cache 240.

The data cache 240 holds a data set collection 250 that may be referred to by other objects, such as data view components. At first, the data set collection 250 may be empty. The data loader 260 takes care of communicating over a network 270 to an appropriate data source 280 when a requested data set is not currently in the data cache 240.

The data cache 240 also maintains a reference count for each of the data sets in the data set collection 250, and potentially makes decisions regarding eviction of a data set. For instance, the data cache 240 might remove of a data set from cache when there are no references to the data set, after potentially providing the most recently copy of the data set over the network 270 to a storage service (such as perhaps the data source 280 of FIG. 2).

In one embodiment, the user interface control 210, the display logic processing component 211 and the business logic component 212 may be running on the same computing system (and perhaps the same machine), such as the computing system 100 of FIG. 1. Furthermore, the data cache 240 may also be present on that same computing system.

In accordance with various embodiments described herein, the data view component may improve the user experience by exposing a default data set (such as a null data set) until the requested data set is available, by exposing only the latest requested data set when there are multiple requests, by quickly switching bindings from one data set to another, and/or by safely releasing the binding once the user interface element display logic component ceases to exist. Furthermore, this may be performed without requiring extensive coding on the part of application or extension developers that author applications or application extensions that use the data caching system.

For instance, the following code may be used by an application or extension developer to create the data cache 240 (line number is added for clarity):

| | |
|---|---|
| 1 | public websiteEntities = new |
| | MsPortalFx.Data.EntityCache<DataModels.WebsiteModel, number>({ |
| 2. | entityTypeName: DataModels.WebsiteModelType, |
| 3. | sourceUri: MsPortalFx.Data.uriFormatter(Data.Shared.websiteById- |
| | Uri) |
| 4. | }); |

Here, in line 1, the “EntityCache” is the data cache 240.

Further, the following represents the code for a view model class representing an example of the class from which the display logic component 211 may be instantiated (with line numbering added for clarity):

| | |
|---|---|
| 1. | /** |
| 2. | * View model |
| 3. | */ |
| 4. | export class BrowseDetailPartViewModel { |
| 5. | public website: KnockoutObservableBase<WebsiteModel>; |
| 6. | private _websiteEntityView: MsPortalFx.Data.EntityView<WebsiteModel, |
| | number>; |
| 7. | /** |
| 8. | * Initializes the website detail form. |
| 9. | */ |
| 10. | constructor(container: MsPortalFx.ViewModels.PartContainerContract, |
| | initialState: any, dataContext: DataContext) { |
| 11. | this._websiteEntityView = |
| | dataContext.masterDetailBrowseSample.websiteEntities.createView(c |
| | ontainer); |
| 12. | this.website = this._websiteEntityView.item; |
| 13. | } |
| 14. | /** |
| 15. | * Invoked when the Part's inputs change. |
| 16. | */ |
| 17. | public onInputsSet(inputs: any): MsPortalFx.Base.Promises.Thenable { |
| 18. | return this._websiteEntityView.fetch(inputs.currentItemId); |
| 19. | } |
| 20. | } |

Line 11 is where the view model (an example of the display logic component 211) acquires a DataView (an example of the data view 213). Notice that the view model passes “container”, which is an indicator to DataView that it is to share the same lifetime as the enclosing view model. More regarding this container will be described below.

Line 12 is where the view model binds the value from the DataView. This is done in the constructor, and thus is performed a single time for the lifetime of the view model.

The “fetch” command (e.g., in line 18) is where the view model is bound or rebound to inputs. This “fetch” call results in the data cache 240 issuing a web request to populate the needed data set in the data cache 240 (assuming the data set is not already present in the data cache). For instance, in FIG. 2, the data loader 260 would issue a request (e.g., perhaps an ajax request) to the data source 280 over the network 270. Furthermore, the reference 203 might be created in response to the fetch call. The reference 203 might also change to a different data set if the fetch call requires a different data set be referred to by the data view. As will be described further below, the data view (e.g., the data view component 213) only notifies when the most recently issued network (e.g., ajax) request completes. In the example, this notification is done via the “Thenable” references returned by the DataView in line 17.

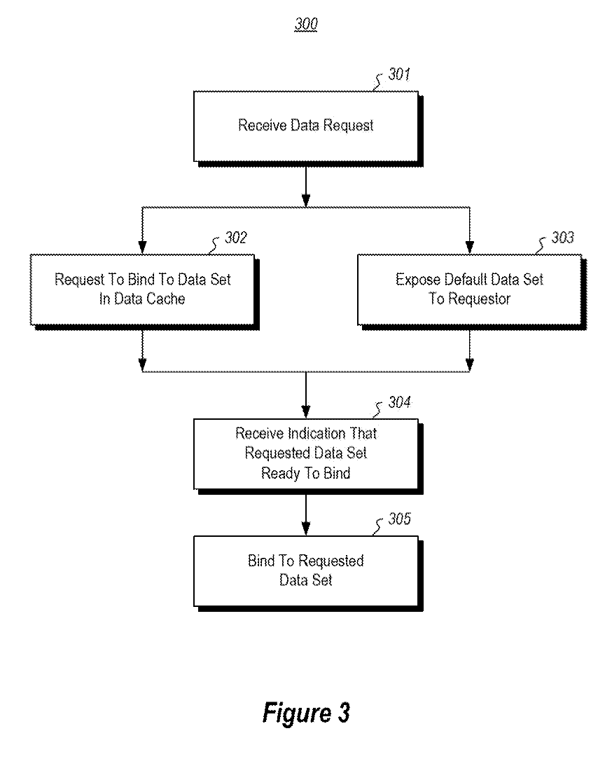

FIG. 3 illustrates a flowchart of a method 300 of the data view component exposing a default data set until the requested data set is available. The data view component receives a request (act 301) to access at least a portion of a data set. For instance, in FIG. 2, the data view component 213 receives a request from the display logic component 211 for at least a portion of a data set.

The data view component then requests (act 302) the data set from the data cache. For instance, in FIG. 2, the data view component 213 may request to bind to the data set 251 from the data cache 240. If the data set 251 were not already within the data cache 240, then the data loader 260 may submit a web request to a data source 280 over the network 270.

While waiting for the requested data set from the data cache, the data view component exposes (act 303) at least a portion of a default data set to the user interface element display logic component. With reference to FIG. 2, the default data set may be held by the data view component 213 for temporary population of a user interface control, while the real data set of interest is being retrieved. As an example, the default data set may be a null data set (such as an empty array or a null value in the case where a single object is requested).

The data view component then receives (act 304) an indication from the data cache that the requested data set is available for binding. In response, the data view component binds (act 305) to the requested data set. For instance, in FIG. 2, the data view component 213 formulates a reference 203 to the requested data set 251. This would cause the requested data to be exposed to the display logic component 211.

Accordingly, a user interface control 210 may be quickly formulated and populated with temporary data, even while the real data of interest is being retrieved. The exposed portion of the default data set may be of the same type as the ultimately exposed portion of the requested data set. Thus, the user interface control may easily populate the user interface element.

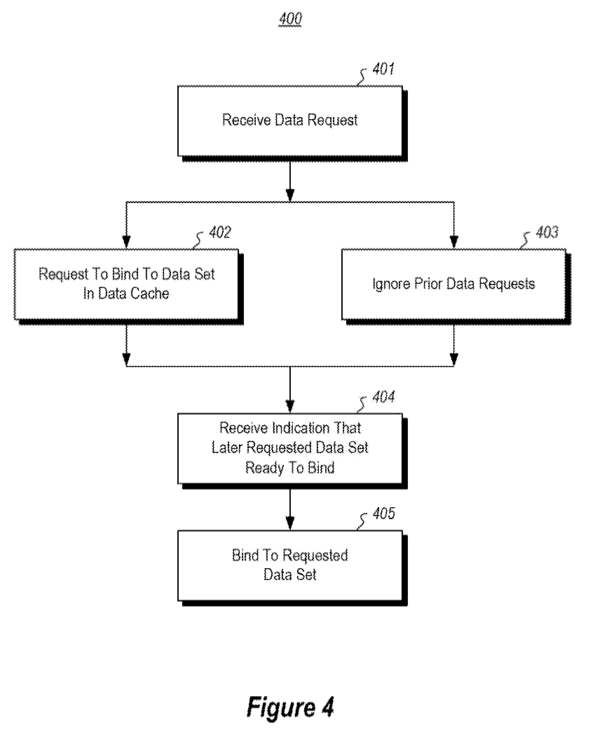

FIG. 4 illustrates a flowchart of a method 400 of the data view component exposing only the latest requested data set when there are multiple requests. The data view component receives a request (act 401) to access at least a portion of a data set. For instance, in FIG. 2, the data view component 213 receives a request from the display logic component 211 for at least a portion of a data set 251.

The data view component then requests (act 402) the data set from the data cache. For instance, in FIG. 2, the data view component 213 may request to bind to the data set 251 from the data cache 240. If the data set 251 were not already within the data cache 240, then the data loader 260 may submit a web request to a data source 280 over the network 270.

The data view component also refrains from honoring any responses to prior data view requests (act 403). For instance, referring to FIG. 2, suppose that the data view component 213 previously received a request from the display logic component 211, resulting in the data view component 213 submitting a request for a data set 252 from the data cache. A race condition is set up if the data view component 213 then receives the response that results in the data view component 213 submitting a request for the data set 251. The data view component takes care of this by refraining from reacting to the first response. Accordingly, if the data cache 240 returns with an indication that the data set 252 is ready for binding, the data view component 213 will ignore that response and simply await the indication that the later requested data set 251 is ready for binding.

Once the data view component receives the indication from the data cache that the later requested data set is ready for binding (act 404), the data view component binds (act 405) to the requested data set. For instance, in FIG. 2, the data view component 213 formulates a reference 203 to the requested data set 251. This would cause the requested data to be exposed to the display logic component 211.

The method 400 may be particularly useful when the data cache 240 responds with indications that various data sets are ready for binding in an order that is different than the order in which the data view component requested those data sets. Such might occur if, for example, the prior requested data set must be retrieved from the data source 280, and the second requested data set is already present in the data cache 240. Such might also occur if both data sets must be retrieved from the data source 280, but the later requested data source happens to be returned first.

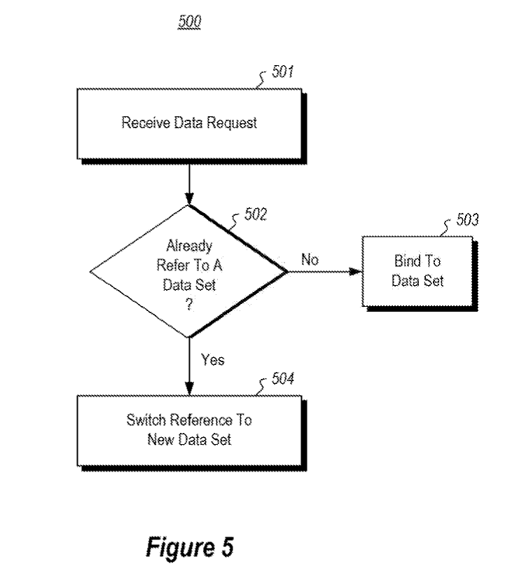

FIG. 5 illustrates a flowchart of a method 500 of the data view component switching bindings from one data set to another. The data view component receives a request (act 501) to access at least a portion of a data set. For instance, in FIG. 2, the data view component 213 receives a request from the display logic component 211 for at least a portion of a data set 251.

Initially, the data view component 213 is not yet bound to a data set (“No” in decision block 502), and thus the data view component constructs a reference and points the reference to the data set (act 503). For instance, in FIG. 2, the data view component 213 formulates the reference 203 to the data set 251. This completes this instance of the method 500.

However, subsequently, the data view component may receive another request (act 501) to access at least a portion of a data set. For instance, in FIG. 2, the data view component 213 receives a request from the display logic component 211 for at least a portion of a data set 252.

Now, the data view component 213 is bound to a data set (“Yes” in decision block 502), and thus the data view component switches the reference to refer to the new data set (act 504). For instance, in FIG. 2, the data view component 213 formulates a reference (not shown) to the new data set 522, and removes the reference 203 to the old data set 521. This completes this second instance of the method 500.

Thus, the method 500 may repeat any number of times to change the data set that is pointed to by the reference held by the data view component 213. This is all performed without the need to reconstruct the data view component.

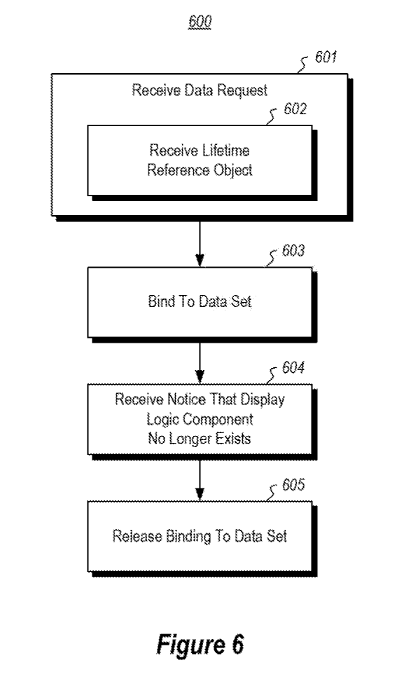

FIG. 6 illustrates a flowchart of a method 600 of the data view component safely releasing the binding once the user interface element display logic component ceases to exist. The data view component receives a request (act 601) to access at least a portion of a data set. For instance, in FIG. 2, the data view component 213 receives a request from the display logic component 211 for at least a portion of a data set 251.

Also, the data view component receives (act 602) a lifetime reference object. For instance, the lifetime reference object may have been passed as a parameter in the request (in act 601). However, the lifetime reference object may also otherwise be received as a result of the request and may be received from the display logic component. In one embodiment, lifetime reference objects expire immediately after the display logic component ceases to exist.

The data view component then binds (act 603) to the data set in response to the request (of act 601). For instance, in FIG. 2, the data view component 213 references the data set 251, and thus exposes at least a portion of the data set 251 upward to the display logic component 211.

If the display logic component that corresponds to the lifetime reference object were to ever cease to exist, the data view component would receive (act 604) notice that the display logic component no longer exists by virtue of the data view component possessing the lifetime reference object. For instance, in FIG. 2, if the display logic component 211 were to cease to exist (e.g., due to the user closing the user interface element that was created and populated by the user interface control 210), the data view component 213 would receive notice that the display logic component 211 has ceased to exist. For instance, the lifetime reference object may expire or cease to exist itself.

Accordingly, the data view component may release (act 605) the binding to the data set. For instance, in FIG. 2, the data view component 213 may release the reference 203 to the data set 251. Although not shown, if there are no further references to the data set 251, then the data set 251 as a whole may be released (e.g., resulting in eviction immediately or after a certain time of non-use).

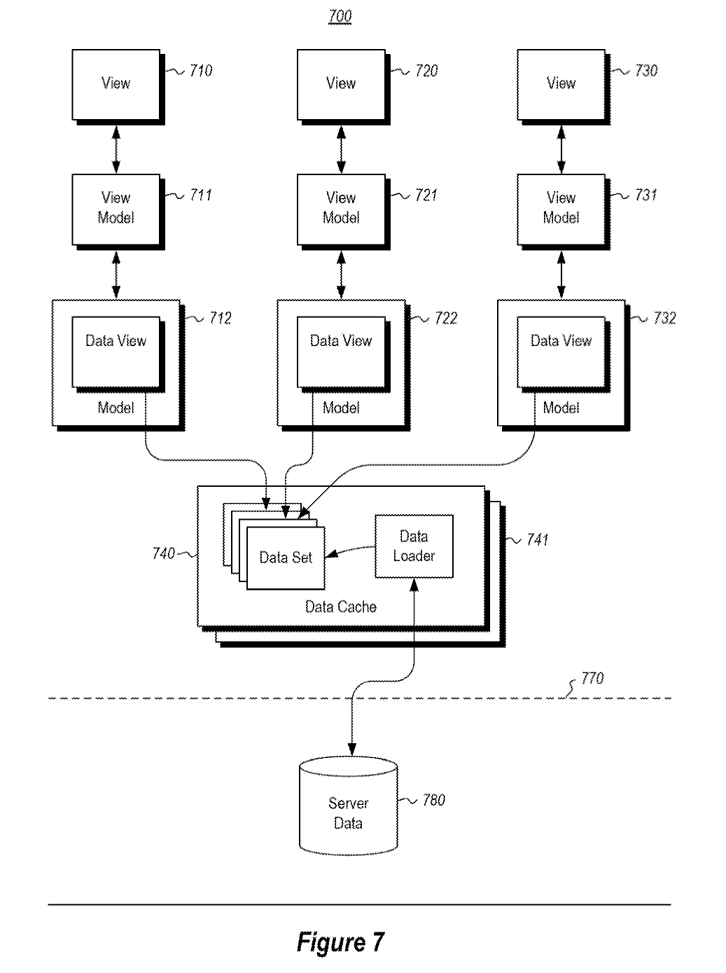

FIG. 7 illustrates an environment 700 that is a specific example of the environment 200 of FIG. 2. However, here, a view 710 is illustrated as an example of the user interface control 210 of FIG. 2. Furthermore, a view model 711 is illustrated as an example of the display logic component 211 of FIG. 2. A model 712 is illustrated as an example of the business logic component 212 of FIG. 2. Finally, the data view 713 is illustrated as an example of the data view component 213 of FIG. 2.

Furthermore, in FIG. 2, there is only one data channel consisting of the collection of the user interface control 210, display logic component 211, business logic component 212 and data view component 213. However, FIG. 7 illustrates that there may be multiple such data channels associated with a single data cache. For instance, view 710, view model 711, model 712 and data view 713 are a single data channel that uses the data cache 740 in order to populate a user interface element under the control of the view 710. FIG. 7 illustrates two additional data channels. As a first additional data channel, the view 720, view model 721, model 722 and data view 713 use the data cache 740 in order to populate a user interface element under the control of the view 720. As a second additional data channel, the view 730, view model 731, model 732 and data view 733 use the data cache 740 in order to populate a user interface element under the control of the view 730. Each data channel may function the same as described above for the original data channel constituting the user interface control 210, the display logic component 211, the business logic component 212, and the data view component 213 of FIG. 2.

FIG. 7 also illustrates a second data cache 741 that may likewise access a data source 780 over the network 770. The data cache 741 may likewise provide data sets to corresponding data channels (not shown) using a corresponding data loader. Thus, the environment 700 may include any number of data caches that each serve zero or more data channels. In one embodiment, each application or application extension may create one or more data caches that are dedicated for that application or application extension.

Thus, the principles described herein provide a data view component that may improve the user experience by exposing a default data set until the requested data set is available, by exposing only the latest requested data set when there are multiple requests, by quickly switching bindings from one data set to another, and/or by safely releasing the binding one the user interface element display logic component ceases to exist.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-20. (canceled)

21. A computer-implemented method performed by one or more processors of a computing system which includes a memory containing computer-executable instructions which cause the one or more processors to perform the computer-implemented method, and wherein the computer-implemented method is used to control display of requested data to user in a manner that improves the user experience, the computer-implemented method comprising:
storing within a computing system a data cache comprised of a plurality of data sets;
the one or more processors initiating within the computing system a user interface (UI) control, a display logic component and a data view component;
receiving at the data view component a request to access the stored data cache for a particular data set; and
the data view component performing at least one of the following actions:
while waiting to bind to the requested particular data set from the data cache, causing a default data set to be exposed at the UI control until the requested particular data set is ready to bind and is then available from the data cache after binding;
while waiting to bind to the requested particular data set from the data cache, causing a second data set that is requested after the requested particular data set to be exposed at the UI control before the requested particular data set;
switching bindings from the requested particular data set to a different requested data set; and
releasing a binding to the requested particular data set once the display logic component is no longer running due to closing a UI element in the UI control.

22. The computer-implemented method as defined in claim 21, wherein, while waiting to bind the requested particular data set from the data cache, the view component performs the action of causing a default data set to be exposed at the UI control until the requested particular data set is ready to bind and is then available from the data cache after binding, and wherein causing the default data set to be exposed at the UI control comprises:
the data view component inputting to the display logic component a null data set which serves as the default data set;
the display logic component inputting the null data set to the UI control for display;
receiving at the data view component an indication that the requested particular data set is ready to bind; and
the data view component binding the requested particular data set and then exposing the requested particular data set to the display logic component to be formatted, and then input to the UI control for display.

23. The computer-implemented method as defined in claim 22, further comprising causing the default data set to no longer be exposed to the UI control once the requested particular data set is ready to be exposed to the UI control.

24. The computer-implemented method as defined in claim 21, wherein the default data set is of the same type as the requested particular data set.

25. The computer-implemented method as defined in claim 21, wherein the display logic component is a view model.

26. The computer-implemented method as defined in claim 21, wherein, while waiting to bind the requested particular data set from the data cache, the view component performs the action of causing a second data set that is requested after the requested particular data set to be exposed at the UI control before the requested particular data set, and wherein causing the second data set to be exposed comprises:
issuing from the data view component to the data cache a first request to bind to the requested particular data set;
while the data view component has not yet been bound to the requested particular data set, the data view component receiving the request to access the second data set;
issuing from the data view component to the data cache a second request to bind to the second data set; and
after issuing the second request to bind to the second data set, the data view component refraining from honoring responses to the first request to bind to the requested particular data set and instead binding to the second data set.

27. The computer-method as defined in claim 26, wherein the requested particular data set is not located in the data cache at the time of the first request to bind.

28. The computer-method as defined in claim 27, wherein the second data set is located in the data cache at the time of the second request to bind.

29. The method in accordance with claim 27, wherein the second data set is not located in the data cache at the time of the second request to bind.

30. The computer-implemented method as defined in claim 21, wherein the view component performs the action of switching bindings from the requested particular data set to a different requested data set, and wherein switching bindings is performed by:
the data view component constructing a reference which points to the requested particular data set;
the data view component using the constructed reference to bind the requested particular data set;
after the data view component binds to the requested particular data set, receiving at the data view component a second request to access a second data set;
the data view component thereafter switching the constructed reference so that the constructed reference refers to the second data set; and
the data view component thereafter using the constructed reference to bind to the second data set.

31. The computer-implemented method as defined in claim 30, wherein references for any of the plurality of data sets within the data cache are monitored at the data cache.

32. The computer-implemented method as defined in claim 31, the data cache maintains a reference count for each of the data sets.

33. The computer-implemented method as defined in claim 32, wherein the reference count is used to determine when a data set is to be evicted from the data cache.

34. The computer-implemented method as defined in claim 21, wherein the view component performs the action of releasing a binding to the requested particular data set once the display logic component is no longer running due to closing a UI element in the UI control, and wherein releasing the binding comprises:
receiving at the data view component a lifetime reference object from the display logic component, the lifetime reference object being passed to the data view component as a parameter in the request for the particular data set;
the data view component binding to the requested particular data set in response to the request;
the data view component receiving notice that the display logic component no longer exists by virtue of the data view component possessing the lifetime reference object; and
the data view component thereafter releasing the binding to the requested particular data set.

35. A computer program product comprised of one or more storage devices containing computer-executable instructions which, when executed, cause one or more processors of a computing system to perform a computer-implemented method used to control display of requested data to user in a manner that improves the user experience, and wherein the computer-implemented method comprises:
storing within a computing system a data cache comprised of a plurality of data sets;
the one or more processors initiating within the computing system a user interface (UI) control, a display logic component and a data view component;
receiving at the data view component a request to access the stored data cache for a particular data set; and
the data view component performing at least one of the following actions:
while waiting to bind to the requested particular data set from the data cache, causing a default data set to be exposed at the UI control until the requested particular data set is ready to bind and is then available from the data cache after binding;
while waiting to bind to the requested particular data set from the data cache, causing a second data set that is requested after the requested particular data set to be exposed at the UI control before the requested particular data set;
switching bindings from the requested particular data set to a different requested data set; and
releasing a binding to the requested particular data set once the display logic component is no longer running due to closing a UI element in the UI control.

36. The computer program product as defined in claim 35, wherein, while waiting to bind the requested particular data set from the data cache, the view component performs the action of causing a default data set to be exposed at the UI control until the requested particular data set is ready to bind and is then available from the data cache after binding, and wherein causing the default data set to be exposed at the UI control comprises:
the data view component inputting to the display logic component a null data set which serves as the default data set;
the display logic component inputting the null data set to the UI control for display;
receiving at the data view component an indication that the requested particular data set is ready to bind; and
the data view component binding the requested particular data set and then exposing the requested particular data set to the display logic component to be formatted, and then input to the UI control for display.

37. The computer program product as defined in claim 35, wherein, while waiting to bind the requested particular data set from the data cache, the view component performs the action of causing a second data set that is requested after the requested particular data set to be exposed at the UI control before the requested particular data set, and wherein causing the second data set to be exposed comprises:
issuing from the data view component to the data cache a first request to bind to the requested particular data set;
while the data view component has not yet been bound to the requested particular data set, the data view component receiving the request to access the second data set;
issuing from the data view component to the data cache a second request to bind to the second data set; and
after issuing the second request to bind to the second data set, the data view component refraining from honoring responses to the first request to bind to the requested particular data set and instead binding to the second data set.

38. The computer program product as defined in claim 35, wherein the view component performs the action of switching bindings from the requested particular data set to a different requested data set, and wherein switching bindings is performed by:
the data view component constructing a reference which points to the requested particular data set;
the data view component using the constructed reference to bind the requested particular data set;
after the data view component binds to the requested particular data set, receiving at the data view component a second request to access a second data set;
the data view component thereafter switching the constructed reference so that the constructed reference refers to the second data set; and
the data view component thereafter using the constructed reference to bind to the second data set.

39. The computer program product as defined in claim 35, wherein the view component performs the action of releasing a binding to the requested particular data set once the display logic component is no longer running due to closing a UI element in the UI control, and wherein releasing the binding comprises:
receiving at the data view component a lifetime reference object from the display logic component, the lifetime reference object being passed to the data view component as a parameter in the request for the particular data set;
the data view component binding to the requested particular data set in response to the request;
the data view component receiving notice that the display logic component no longer exists by virtue of the data view component possessing the lifetime reference object; and
the data view component thereafter releasing the binding to the requested particular data set.

40. A computer system comprising:
one or more processors;
a display;
system memory containing computer-executable instructions which, when executed, cause the one or more processors to perform a computer-implemented method used to control display of requested data to user in a manner that improves the user experience, and wherein the computer-implemented method comprises:
storing within a computing system a data cache comprised of a plurality of data sets;
the one or more processors initiating within the computing system a user interface (UI) control, a display logic component and a data view component;
receiving at the data view component a request to access the stored data cache for a particular data set; and
the data view component performing at least one of the following actions:
while waiting to bind to the requested particular data set from the data cache, causing a default data set to be exposed at the UI control until the requested particular data set is ready to bind and is then available from the data cache after binding;
while waiting to bind to the requested particular data set from the data cache, causing a second data set that is requested after the requested particular data set to be exposed at the UI control before the requested particular data set;
switching bindings from the requested particular data set to a different requested data set; and
releasing a binding to the requested particular data set once the display logic component is no longer running due to closing a UI element in the UI control.
